(19) United States
(12) Patent Application Publication
(10) Pub. No.: US 2014/0303341 A1
(43) Pub. Date: Oct. 9, 2014

(54) Polyamide Resin, Preparation Method Thereof, and Article Comprising Same

(71) Applicant: Cheil Industries Inc., Gumi-si (KR)

(72) Inventors: Seung Hyun Jang, Uiwang-si (KR); Ki Yon Lee, Uiwang-si (KR); Young Sub Jin, Uiwang-si (KR); Suk Min Jun, Uiwang-si (KR); Tomoaki Shimoda, Uiwang-si (KR); Sang Kyun Im, Uiwang-si (KR)

(73) Assignee: Cheil Industries Inc., Gumi-si, Gyeongsangbuk-do (KR)

(21) Appl. No.: 14/363,875

(22) PCT Filed: Dec. 11, 2012
(86) PCT No.: PCT/KR2012/010733

§ 371 Date: Jun. 9, 2014

(30) Foreign Application Priority Data
Dec. 13, 2011 (KR) 10-2011-0134037

(51) Int. Cl. C08G 69/26; C08G 69/04

(52) U.S. Cl. CPC C08G 69/265; C08G 69/04
USPC 528/338

(57) ABSTRACT

The present invention relates to: a polyamide resin which is a copolymer of a mixture comprising (a1) one or more aliphatic diamine monomers selected from C₄ to C₁₀ aliphatic diamines, and (a2) one or more aliphatic diamine monomers selected from C₁₁ to C₁₈ aliphatic diamines, and a mixture comprising (b1) one or more aromatic dicarboxylic acid monomers selected from aromatic dicarboxylic acids, and (b2) one or more aliphatic dicarboxylic acid monomers selected from C₄ to C₁₄ aliphatic dicarboxylic acids, and has an amine and acid end group number greater than about 0 μeq/g to about 150 μeq/g; a preparation method thereof; and an article comprising the same.

### TECHNICAL FIELD

The present invention relates to a polyamide resin, a method for preparing the same, and an article including the same.

### BACKGROUND ART

As a polyamide resin, nylon 66 and nylon 6 are most well known. Such an aliphatic polyamide resin is widely applied to automobile components, electronics, mechanical components, and the like. However, the aliphatic polyamide resin does not exhibit sufficient thermal stability for application to fields requiring high heat resistance.

Although an aromatic polyamide resin has a higher melting point and higher heat resistance than the aliphatic polyamide resin, the aromatic polyamide resin has a limit in processability due to the high melting point thereof. As such, although various attempts have been made to improve moldability or absorption of the polyamide resin, polyamide resins developed to date have yet to achieve sufficient improvement in properties.

### DISCLOSURE

### Technical Problem

An object of the present invention is to provide a polyamide resin exhibiting excellent melt processability, high reflectance, and low absorption.

Another object of the present invention is to provide a method for preparing the polyamide resin as set forth above.

A further object of the present invention is to provide an article including the polyamide resin as set forth above or a polyamide resin prepared by the method as set forth above.

### Technical Solution

In accordance with one aspect of the present invention, a polyamide resin may have amine and acid end group numbers, each of which is greater than about 0 μeq/g to about 150 μeq/g.

In accordance with another aspect of the present invention, a method for preparing a polyamide resin may include copolymerizing: a mixture including about 0.1 mol % to about 70 mol % of (a2) at least one aliphatic diamine monomer selected from among C₁₁ to C₁₈ aliphatic diamines, and the balance of (a1) at least one aliphatic diamine monomer selected from among C₄ to C₁₀ aliphatic diamines; and a mixture including about 0.1 mol % to about 70 mol % of (b2) at least one aliphatic dicarboxylic acid monomer selected from among C₄ to C₁₄ aliphatic dicarboxylic acids, and the balance of (b1) at least one aromatic dicarboxylic acid monomer selected from among aromatic dicarboxylic acids.

In accordance with a further aspect of the present invention, an article may include the polyamide resin as set forth above or a polyamide resin prepared by the method as set forth above.

### Advantageous Effects

The present invention provides a polyamide resin exhibiting excellent melt processability, high reflectance and low absorption, a method for preparing the polyamide resin, and an article including the polyamide resin.

### BEST MODE

As used herein, the term “aliphatic diamines” may refer to aliphatic hydrocarbon diamines.

As used herein, the term “aromatic dicarboxylic acids” may refer to aromatic hydrocarbon dicarboxylic acids.

As used herein, the term “aliphatic dicarboxylic acids” may refer to aliphatic hydrocarbon dicarboxylic acids.

In accordance with one aspect of the present invention, a polyamide resin may have an end group number of greater than about 0 μeq/g to about 150 μeq/g. If the end group number is greater than about 150 μeq/g, the polyamide resin has too low molecular weight and thus exhibits poor properties in terms of thermal properties, shape stability, chemical resistance, and the like. Preferably, the polyamide resin has amine and acid end group numbers, each of which is greater than about 0 μeq/g to about 150 μeq/g, more preferably from about 20 μeq/g to about 82 μeq/g.

The amine end group number can be measured by a method known in the art. For example, 1 g of a polyamide resin is added to a mixed solvent of phenol and methanol (phenol:methanol=9:1, volume ratio), followed by dissolving the polyamide resin in the solvent while stirring. Next, the mixture is subjected to neutralization titration with a 0.02 N hydrochloric acid solution using Thymol blue as an indicator, thereby determining the amine end group number.

The term “amine” may refer to —NH₂.

The polyamide resin may have an acid end group number, particularly a carboxylic acid end group number of greater than about 0 μeq/g to about 150 μeq/g or less. Within this range, the polyamide resin can exhibit good properties in terms of high heat resistance, shape stability, low absorption, chemical resistance, and the like. Preferably, the polyamide resin has a carboxylic acid end group number from about 20 μeq/g to about 82 μeq/g.

The carboxylic acid end group number can be measured by a method known in the art. For example, 1 g of a polyamide resin is added to 40 ml of benzyl alcohol, followed by heating to 180° C. Next, the mixture is subjected to neutralization titration with a 0.05 N sodium hydroxide solution using phenolphthalein as an indicator, while stirring, thereby determining the carboxylic acid end group number.

The polyamide resin includes a flexible monomer and thus can exhibit excellent melt processability, high reflectance and low absorption.

In one embodiment, the polyamide resin may be a copolymer of a mixture of (a1) at least one aliphatic diamine monomer selected from among C₄ to C₁₀ aliphatic diamines and (a2) at least one aliphatic diamine monomer selected from among C₁₁ to C₁₈ aliphatic diamines, and a mixture of (b1) at least one aromatic dicarboxylic acid monomer selected from among aromatic dicarboxylic acids and (b2) at least one aliphatic dicarboxylic acid monomer selected from among C₄ to C₁₄ aliphatic dicarboxylic acids.

Preferably, the mixture of the aliphatic diamine monomers includes the (a1) at least one aliphatic diamine monomer selected from among C₄, C₆, C₈ and C₁₀ aliphatic diamines, and the (a2) at least one aliphatic diamine monomer selected from among C₁₂, C₁₄, C₁₆ and C₁₈ aliphatic diamines.

Since both the (a1) aliphatic diamine monomer and the (a2) aliphatic diamine monomer have an even number of carbons, the polyamide resin can exhibit much higher heat resistance than when the aliphatic diamine monomers have even and odd numbers of carbons, or odd and odd numbers of carbons, respectively.

The (a2) aliphatic diamine monomer may be present in an amount of about 0.1 mol % to about 70 mol % in the mixture of the aliphatic diamine monomers (a1)+(a2). Within this range, the polyamide resin can have balance of physical properties between processability and mechanical strength. Preferably, the (a2) aliphatic diamine monomer is present in an amount of about 1 mol % to about 50 mol %, more preferably about 9.9 mol % to about 30.5 mol %, still more preferably about 10 mol % to about 30 mol %.

The (a1) aliphatic diamine monomer may be present in the balance amount excluding the amount of the (a2) aliphatic diamine monomer in the mixture of the aliphatic diamine monomers (a1)+(a2). Preferably, the (a1) aliphatic diamine monomer is present in an amount of about 30 mol % to about 99.9 mol %. Within this range, the polyamide resin can have balance of physical properties between processability and mechanical strength. Preferably, the (a1) aliphatic diamine monomer is present in an amount of about 50 mol % to about 99 mol %, more preferably about 69.5 mol % to about 90.1 mol %, still more preferably about 70 mol % to about 90 mol %.

The (a1) aliphatic diamine monomer may be a linear or branched C₄ to C₁₀ aliphatic diamine monomer. For example, the (a1) aliphatic diamine monomer may include at least one of 1,4-butanediamine, 1,6-hexanediamine, 1,7-heptanediamine, 1,8-octanediamine, 1,10-decanediamine, 3-methyl-1,5-pentanediamine, 2,2,4-trimethyl-1,6-hexanediamine, 2,4,4-trimethyl-1,6-hexanediamine, 5-methyl-1,9-nonanediamine, 2,2-oxybis(ethylamine), bis(3-aminopropyl) ether, ethylene glycol bis(3-aminopropyl) ether (EGBA), 1,7-diamino-3,5-dioxoheptane, and 2-butyl-2-ethyl-1,5-pentanediamine, without being limited thereto.

The (a2) aliphatic diamine monomer may be a linear or branched C₁₁ to C₁₈ aliphatic diamine monomer. For example, the (a2) aliphatic diamine monomer may include 1,11-undecanediamine, 1,12-dodecanediamine, 1,13-tridecanediamine, 1,14-tetradecanediamine, 1,16-hexadec anedi amine, 1,18-octadecanediamine, 1,11-diamino-6-oxoundecane, 1,11-diamino-4,8-dioxo-undecane, 1,11-diamino-4,8-dioxo-5-ethylundecane, 1,12-diamino-4,9-dioxododecane, 1,13-diamino-4,10-dioxotridecane, 1,14-diamino-4,11-dioxotetradecane, 1,11-diamino-4, 8-dioxo-5,6-dimethyl-7-propionylundecane, 1,14-diamino-4,7,10-trioxo-tetradecane, 1,13-diamino-4,7,10-trioxo-5,8-dimethyltridecane, 1,16-diamino-4,7,10,13-tetraoxohexadecane, 1,10-diamino-4,7-dioxoundecane, and 1,10-diamino-4,7-dioxo-5-methyldecane, without being limited thereto.

The (b2) aliphatic dicarboxylic acid monomer may be present in an amount of about 0.1 mol % to about 70 mol % in the mixture of the dicarboxylic acid monomers (b1)+(b2). Within this range, the polyamide resin can have balance of physical properties between processability and mechanical strength. Preferably, the (b2) aliphatic diamine monomer is present in an amount of about 1 mol % to about 50 mol %, more preferably about 10 mol % to about 50 mol %.

The (b1) aromatic dicarboxylic acid monomer may be present in the balance amount excluding the amount of the (b2) aliphatic dicarboxylic acid monomer in the mixture of the dicarboxylic acid monomers (b1)+(b2). Preferably, the (b1) aromatic dicarboxylic acid monomer is present in an amount of about 30 mol % to about 99.9 mol %. Within this range, the polyamide resin can have balance of physical properties between processability and mechanical strength. Preferably, the (b1) aromatic dicarboxylic acid monomer is present in an amount of about 50 mol % to about 99 mol %, more preferably about 50 mol % to about 90 mol %.

The (b1) aromatic dicarboxylic acid monomer may include terephthalic acid, isophthalic acid, 2,6-naphthalenedicarboxylic acid, 2,7-naphthalenedicarboxylic acid, 1,4-naphthalenedicarboxylic acid, 1,4-phenylenedioxyphenylene acid, 1,3-phenylenedioxydiacetic acid, diphenic acid, 4′,4′-oxybis(benzoic acid), diphenylmethane-4,4′-dicarboxylic acid, diphenylsulfone-4,4′-dicarboxylic acid, 4-4′-diphenylcarboxylic acid, and the like.

The (b2) aliphatic dicarboxylic acid monomer may include succinic acid, glutaric acid, adipic acid, pimelic acid, suberic acid, azelaic acid, sebacic acid, undecanedioic acid, dodecanedioic acid, glutamic acid, traumatic acid, and muconic acid, without being limited thereto.

A ratio (R) of a total mole number of the (a1) aliphatic diamine monomer and the (a2) aliphatic diamine monomer to a total mole number of the (b1) aromatic dicarboxylic acid monomer and the (b2) aliphatic dicarboxylic acid monomer may range from about 0.9 to about 1.3. Within this range, the polyamide resin can exhibit fluidity, mechanical strength, and low absorption. Preferably, the ratio (R) ranges from about 1.01 to about 1.30, more preferably from about 1.015 to about 1.02.

The polyamide resin may include an end group encapsulated with an end capping agent selected from among aliphatic carboxylic acids and aromatic carboxylic acids.

The end capping agent may include acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, α-naphthalenecarboxylic acid, β-naphthalenecarboxylic acid, and methylnaphthalenecarboxylic acid, without being limited thereto.

The end capping agent is optionally present in an amount of about 0 mol % to about 5 mol %, preferably about 0.01 mol % to about 3 mol % based on 100 mol % of (a1)+(a2)+(b1)+(b2).

The polyamide resin has an intrinsic viscosity (η) from about 0.3 dL/g to about 4.0 dL/g, preferably from about 0.8 dL/g to about 1.1 dL/g, as measured at 25° C. in a 97% sulfuric acid solution using an Ubbelohde viscometer.

The polyamide resin has a strength retention of about 90% or more, preferably from about 90% to about 95%. Here, the strength retention refers to a ratio of tensile strengths before and after treatment at 80° C. and 95% RH for 24 hours in accordance with ISO 527 (23° C., 5 mm/min) In addition, the polyamide resin has a water absorption of about 0.5% or less, preferably from about 0.1% to about 0.5%, as measured after treatment at 50° C. and 90% RH for 48 hours.

In accordance with another aspect of the invention, a method for preparing a polyamide resin may include copolymerizing: a mixture including about 0.1 mol % to about 70 mol % of (a2) at least one aliphatic diamine monomer selected from among C₁₁ to C₁₈ aliphatic diamines, and the balance of (a1) at least one aliphatic diamine monomer selected from among C₄ to C₁₀ aliphatic diamines; and a mixture including about 0.1 mol % to about 70 mol % of (b2) at least one aliphatic dicarboxylic acid monomer selected from among C₄ to C₁₄ aliphatic dicarboxylic acids, and the balance of (b1) at least one aromatic dicarboxylic acid monomer selected from among aromatic dicarboxylic acids.

Copolymerization is performed by a typical method for preparation of a copolymer, preferably melt polymerization.

Copolymerization is performed at a polymerization temperature from about 80° C. to about 300° C., preferably from about 80° C. to about 280° C., and at a polymerization pressure from about 10 kgf/cm² to about 40 kgf/cm².

In one embodiment, the mixture of the (a1) aliphatic diamine monomer and the (a2) aliphatic diamine monomer, the mixture of the (b1) aromatic dicarboxylic acid monomer and the (b2) aliphatic dicarboxylic acid monomer, a catalyst, and water are placed in a reactor, followed by stirring at about 80° C. to about 150° C. for about 0.5 hours to about 2 hours. In the reactor, the components are heated to about 200° C. to about 280° C. for about 2 hours to about 4 hours while the pressure is maintained at about 20 kgf/cm² to about 40 kgf/cm², followed by lowering the pressure to about 10 kgf/cm² to about 20 kgf/cm², and then subjected to reaction for about 1 hour to about 3 hours. Here, the obtained polyamide is subjected to solid state polymerization at a temperature between glass transition temperature (Tg) and melting point (Tm) thereof in a vacuum for about 10 hours to about 30 hours, thereby obtaining a final reaction product.

Polymerization may be performed using a catalyst, preferably a phosphorus catalyst. Specifically, the catalyst may include phosphoric acid, phosphorous acid, hypophosphorous acid, salts or derivatives thereof, and the like. More specifically, the catalyst may include phosphoric acid, phosphorous acid, hypophosphorous acid, sodium hypophosphate, sodium hypophosphinate, and the like.

The catalyst is optionally present in an amount of about 0 wt % to about 3.0 wt %, preferably about 0 wt % to about 1.0 wt %, more preferably about 0 wt % to about 0.5 wt %, based on a total weight of the monomers.

When the mixture of the (a1) aliphatic diamine monomer and the (a2) aliphatic diamine monomer, and the mixture of the (b1) aromatic dicarboxylic acid monomer and the (b2) aliphatic dicarboxylic acid monomer are introduced, the end capping agent may be used. The viscosity of the synthesized polyamide resin may be adjusted by adjusting the amount of the end capping agent.

The end capping agent may be an aliphatic carboxylic acid or an aromatic carboxylic acid. In one embodiment, the end capping agent may include acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, α-naphthalenecarboxylic acid, β-naphthalenecarboxylic acid, methylnaphthalenecarboxylic acid, and the like. These may be used alone or in combination thereof.

In accordance with a further aspect of the present invention, an article may include the polyamide resin as set forth above or a polyamide resin prepared by the method as set forth above. For example, the article may be applied to electric and electronic materials, such as ED reflectors and the like, and plastic joints of automobile components, without being limited thereto. The article may be molded using a typical method known in the art.

### MODE FOR INVENTION

Hereinafter, the present invention will be described in more detail with reference to some examples. It should be understood that these examples are provided for illustration only and are not to be construed in any way as limiting the present invention.

### Example 1

0.557 mol (92.56 g) of terephthalic acid, 0.062 mol (12.40 g) of sebacic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.22 g) of sodium hypophosphinate, and 146 mL of water were placed in a 1 L autoclave, followed by filling the autoclave with nitrogen. The components were stirred at 100° C. for 60 minutes, followed by heating to 250° C. for 2 hours. Next, the mixture were subjected to reaction at 250° C. for 3 hours while the autoclave was maintained at a pressure of 25 kgf/cm², followed by lowering the pressure of the autoclave to 15 kgf/cm², and then subjected to reaction for 1 hour, thereby preparing a polyamide pre-copolymer having an intrinsic viscosity of 0.21 dL/g. The polyamide pre-copolymer was subjected to solid state polymerization at 230° C. for 24 hours, thereby obtaining a polyamide resin.

### Example 2

A polyamide resin was prepared in the same manner as in Example 1 except that 0.433 mol (71.99 g) of terephthalic acid, 0.1857 mol (37.21 g) of sebacic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.24 g) of sodium hypophosphinate, and 149 mL of distilled water were used.

### Example 3

A polyamide resin was prepared in the same manner as in Example 1 except that 0.31 mol (51.42 g) of terephthalic acid, 0.3095 mol (62.01 g) of sebacic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.27 g) of sodium hypophosphinate, and 151 mL of distilled water were used.

### Example 4

A polyamide resin was prepared in the same manner as in Example 1 except that 0.557 mol (92.56 g) of terephthalic acid, 0.062 mol (12.40 g) of sebacic acid, 0.442 mol (76.16 g) of 1,10-decanediamine, 0.19 mol (37.95 g) of 1,12-dodecanediamine, 0.025 mol (3.02 g) of benzoic acid, 0.1 wt % (0.22 g) of sodium hypophosphinate, and 148 mL of distilled water were used.

### Example 5

A polyamide resin was prepared in the same manner as in Example 1 except that 0.557 mol (92.56 g) of terephthalic acid, 0.062 mol (14.26 g) of dodecanedioic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.22 g) of sodium hypophosphinate, and 148 mL of distilled water were used.

### Example 6

A polyamide resin was prepared in the same manner as in Example 1 except that 0.557 mol (92.56 g) of terephthalic acid, 0.062 mol (11.65 g) of azelaic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.22 g) of sodium hypophosphinate, and 147 mL of distilled water were used.

### Example 7

A polyamide resin was prepared in the same manner as in Example 1 except that 0.433 mol (71.99 g) of terephthalic acid, 0.186 mol (32.95 g) of azelaic acid, 0.568 mol (97.91 g) of 1,10-decanediamine, 0.063 mol (12.65 g) of 1,12-dodecanediamine, 0.025 mol (3.02 g) of benzoic acid, 0.1 wt % (0.24 g) of sodium hypophosphinate, and 147 mL of distilled water were used.

### Example 8

A polyamide resin was prepared in the same manner as in Example 1 except that 0.433 mol (71.99 g) of terephthalic acid, 0.186 mol (34.95 g) of azelaic acid, 0.4419 mol (76.16 g) of 1,10-decanediamine, 0.189 mol (37.95 g) of 1,12-dodecanediamine, 0.025 mol (3.02 g) of benzoic acid, 0.1 wt % (0.24 g) of sodium hypophosphinate, and 149 mL of distilled water were used.

### Comparative Example 1

0.619 mol (102.841 g) of terephthalic acid, 0.5571 mol (95.994 g) of 1,10-decanediamine, 0.0619 mol (12.40 g) of 1,12-dodecanediamine, 0.1 wt % (0.22 g) of sodium hypophosphinate, and 140 mL of water were placed in a 1 L autoclave, followed by filling the autoclave with nitrogen. Next, a polyamide resin was prepared by the same polymerization method as in Example 1.

### Comparative Example 2

0.619 mol (102.841 g) of terephthalic acid, 0.668 mol (115.19 g) of 1,10-decanediamine, 0.0743 mol (14.88 g) of 1,12-dodecanediamine, 0.248 mol (30.24 g) of benzoic acid, 0.1 wt % (0.21 g) of sodium hypophosphinate, and 175 mL of water were placed in a 1 L autoclave, followed by filling the autoclave with nitrogen. Next, a polyamide resin was prepared by the same polymerization method as in Example 1.

### Comparative Example 3

0.619 mol (125.2 g) of sebacic acid, 0.442 mol (76.155 g) of 1,10-decanediamine, 0.1894 mol (37.951 g) of 1,12-dodecanediamine, 0.025 mol (3.024 g) of benzoic acid, 0.1 wt % (0.34 g) of sodium hypophosphinate, and 161 mL of water were placed in a 1 L autoclave, followed by filling the autoclave with nitrogen. Next, a polyamide resin was prepared by the same polymerization method as in Example 1.

### Comparative Example 4

0.619 mol (102.84 g) of terephthalic acid, 0.3157 mol (54.397 g) of 1,10-decanediamine, 0.3157 mol (63.252 g) of 1,12-dodecanediamine, 0.025 mol (3.024 g) of benzoic acid, 0.1 wt % (0.21 g) of sodium hypophosphinate, and 149 mL of water were placed in a 1 L autoclave, followed by filling the autoclave with nitrogen. Next, a polyamide resin was prepared by the same polymerization method as in Example 1.

### Comparative Example 5

0.4333 mol (71.988 g) of terephthalic acid, 0.1857 mol (37.567 g) of sebacic acid, 0.6314 mol (126.503 g) of 1,12-dodecanediamine, 0.025 mol (3.024 g) of benzoic acid, 0.1 wt % (0.25 g) of sodium hypophosphinate, and 159 mL of water were placed in a 1 L autoclave, followed by filling the autoclave with nitrogen. Next, a polyamide resin was prepared by the same polymerization method as in Example 1.

### Comparative Example 6

0.4333 mol (71.988 g) of terephthalic acid, 0.1857 mol (37.567 g) of sebacic acid, 0.6314 mol (108.793 g) of 1,10-decanediamine, 0.025 mol (3.24 g) of benzoic acid, 0.1 wt % (0.25 g) of sodium hypophosphinate, and 147 mL of water were placed in a 1 L autoclave, followed by filling the autoclave with nitrogen. Next, a polyamide resin was prepared by the same polymerization method as in Example 1.

### Experimental Example

The polyamide resins prepared in Examples and Comparative Examples were evaluated as to properties as listed in Table 1. Results are shown in Tables 1 and 2.

### Property Evaluation

(1) End group number (μeq/g): To determine an amine end group number, 1 g of the polyamide resin was added to a mixed solvent of phenol and methanol (phenol:methanol=9:1, volume ratio), followed by dissolving the polyamide resin under stirring. Next, the mixture was subjected to neutralization titration with a 0.02 N hydrochloric acid solution using an indicator Thymol blue, thereby determining the amine end group number. To determine a carboxylic acid end group number, 1 g of the polyamide resin was added to 40 ml of benzyl alcohol, followed by heating to 180° C. Next, the mixture was subjected to neutralization titration with a 0.05 N sodium hydroxide solution using an indicator phenolphthalein while stirred, thereby determining the carboxylic acid end group number.

(2) Intrinsic viscosity (dL/g): The polyamide resin was dissolved in a 97% sulfuric acid solution, followed by measuring intrinsic viscosity using an Ubbelohde viscometer.

(3) Fluidity (mm): An injection machine (SG75H-MIV, Sumitomo Electric Industries, Inc.) was used. Temperatures of a cylinder and a mold were set to 320° C. and injection pressure was set to 15 MPa to measure a flow distance.

(4) Strength retention (%): Tensile strength of the polyamide resin was measured in accordance with ISO 527 (23° C., 5 mm/min) and a ratio of tensile strength before treatment to tensile strength after treatment at 80° C. and 95% RH in a thermohygrostat for 24 hours was measured as the strength retention.

(5) Water absorption (%): A specimen having a length of 100 mm, a width of 100 mm and a thickness of 3 mm was prepared, followed by drying. Weight (W₀) of the dried specimen was measured, followed by treatment of the specimen at 50° C. and 90% RH in a thermohygrostat for 48 hours. Next, weight (W₁) of the specimen after treatment was measured, thereby calculating water absorption.

Water absorption (%)=[(W₁−W₀/W₀]×100

(6) Yellow index and Reflectance: To prepare a specimen, highly heat resistant nylon, titanium dioxide, and fillers (glass fiber) were added to a twin-screw melt extruder heated to 240° C. to 320° C., followed by melting and kneading, thereby preparing a resin composition in a needle state. Next, the obtained needles were dried at 130° C. for 5 hours or more, followed by preparing a specimen using a screw type injection machine heated to 240° C. to 330° C.

Yellow index (YI) was measured using a colorimeter (3600D CIE Lab., Konica Minolta Inc.).

ΔYI=[YI before treatment at constant temperature and humidity (85° C., 80% RH)]−[YI after treatment at constant temperature and humidity for 96 hours (85° C., 85% RH)]

Reflectance was evaluated by measuring reflectance at 440 nm (specular component included (SCI)) using a colorimeter (3600D CIE Lab., Konica Minolta Inc.).

ΔReflectance=[Reflectance before treatment at constant temperature and humidity (85° C., 80% RH)]−[Reflectance after treatment at constant temperature and humidity for 96 hours (85° C., 85% RH)]

TABLE 1

| | Example 1 | Example 2 | Example 3 | Example 4 | Example 5 | Example 6 | Example 7 | Example 8 |
|---|---|---|---|---|---|---|---|---|
| End group | 40/35 | 50/40 | 70/65 | 55/42 | 78/62 | 55/51 | 82/80 | 72/70 |
| number | | | | | | | | |
| amine/acid | | | | | | | | |
| (μeq/g) | | | | | | | | |
| Intrinsic | 1.0 | 0.92 | 0.86 | 0.95 | 0.83 | 0.96 | 0.90 | 0.85 |
| viscosity | | | | | | | | |
| (dL/g) | | | | | | | | |
| Fluidity | 140 | 145 | 143 | 123 | 151 | 135 | 136 | 144 |
| (mm) | | | | | | | | |
| Strength | 92 | 91 | 90 | 94 | 92 | 91 | 94 | 92 |
| retention | | | | | | | | |
| (%) | | | | | | | | |
| Water | 0.2 | 0.3 | 0.25 | 0.32 | 0.14 | 0.5 | 0.5 | 0.28 |
| absorption | | | | | | | | |
| (%) | | | | | | | | |
| ΔYI (SCI) | 8.5 | 8.0 | 6.0 | 6.3 | 6.2 | 8.4 | 8.3 | 8.1 |
| ΔReflectance | 9.8 | 8.2 | 6.4 | 7.2 | 6.5 | 9.2 | 9.4 | 8.8 |
| (SCI) (%) | | | | | | | | |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| End group number | Unable to be | 300/320 | 210/200 | 165/155 | 162/153 | 155/150 |
| amine/acid | measured | | | | | |
| (μeq/g) | | | | | | |
| Intrinsic viscosity | 1.8 | 0.35 | 0.5 | 0.74 | 0.55 | 0.65 |
| (dL/g) | | | | | | |
| Fluidity | 100 | 170 | 175 | 105 | 110 | 112 |
| (mm) | | | | | | |
| Strength retention | 95 | 50 | 60 | 75 | 60 | 80 |
| (%) | | | | | | |
| Water absorption | 1.2 | 3.2 | 2.8 | 1.4 | 1.5 | 3.0 |
| (%) | | | | | | |
| ΔYI (SCI) | 11 | 15 | 20 | 13 | 12 | 14 |
| ΔReflectance | 12 | 20 | 25 | 14 | 12 | 13 |
| (SCI) (%) | | | | | | |

*Unable to be measured: Not dissolved in a solvent for measuring end group number

As shown in Tables 1 and 2, it can be seen that the polyamide resin according to the invention exhibited excellent melt processability, high reflectance, and low absorption.

It should be understood that the present invention is not limited to the foregoing embodiments and may be embodied in different ways, and that various modifications, changes, alterations, and equivalent embodiments can be made by those skilled in the art without departing from the spirit and scope of the present invention. Therefore, the scope of the invention should be limited only by the accompanying claims and equivalents thereof.

1. A polyamide resin which is a copolymer of:
a mixture of (a1) at least one aliphatic diamine monomer selected from C₄ to C₁₀ aliphatic diamines and (a2) at least one aliphatic diamine monomer selected from C₁₁ to C₁₈ aliphatic diamines; and
a mixture of (b1) at least one aromatic dicarboxylic acid monomer selected from aromatic dicarboxylic acids and (b2) at least one aliphatic dicarboxylic acid monomer selected from C₄ to C₁₄ aliphatic dicarboxylic acids,
the polyamide resin having amine and acid end group numbers, each of which is greater than about 0 μeq/g to about 150 μeq/g.

2. The polyamide resin according to claim 1, wherein the polyamide resin has each of amine and acid end group numbers from about 20 μeq/g to about 82 μeq/g.

3. The polyamide resin according to claim 1, wherein a ratio of a total mole number of the (a1) aliphatic diamine monomer and the (a2) aliphatic diamine monomer to a total mole number of the (b1) aromatic dicarboxylic acid monomer and the (b2) aliphatic dicarboxylic acid monomer ranges from about 0.9 to about 1.3.

4. The polyamide resin according to claim 1, wherein the (a2) aliphatic diamine monomer is present in an amount of about 0.1 mol % to about 70 mol % in (a1)+(a2).

5. The polyamide resin according to claim 1, wherein the (a1) aliphatic diamine monomer is present in an amount of about 30 mol % to about 99.9 mol % in (a1)+(a2).

6. The polyamide resin according to claim 1, wherein at least one of the (a1) aliphatic diamine monomer and the (a2) aliphatic diamine monomer has a branched alkyl group.

7. The polyamide resin according to claim 1, wherein both the (a1) aliphatic diamine monomer and the (a2) aliphatic diamine monomer comprise a linear alkyl group.

8. The polyamide resin according to claim 1, wherein the (b2) aliphatic dicarboxylic acid monomer is present in an amount of about 0.1 mol % to about 70 mol % in (b1)+(b2).

9. The polyamide resin according to claim 1, comprising: an end group encapsulated with an end capping agent selected from aliphatic carboxylic acids and aromatic carboxylic acids.

10. The polyamide resin according to claim 9, wherein the end capping agent comprises at least one selected from the group consisting of acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, α-naphthalenecarboxylic acid, β-naphthalenecarboxylic acid, and methylnaphthalenecarboxylic acid.

11. The polyamide resin according to claim 1, wherein the polyamide resin has an intrinsic viscosity from about 0.3 dL/g to about 4.0 dL/g, as measured at 25° C. in a 97% sulfuric acid solution using an Ubbelohde viscometer.

12. The polyamide resin according to claim 1, wherein the polyamide resin has a ratio of tensile strength before treatment to tensile strength after treatment of about 90% or more, the tensile strength being measured before and after treatment at 80° C. and 95% RH for 24 hours in accordance with ISO 527 (23° C., 5 mm/min), and a water absorption of about 0.5% or less, as measured after treatment at 50° C. and 90% RH for 48 hours.

13. A method for preparing a polyamide resin, comprising:
copolymerizing a mixture comprising about 0.1 mol % to about 70 mol % of (a2) at least one aliphatic diamine monomer selected from C₁₁ to C₁₈ aliphatic diamines and the balance of (a1) at least one aliphatic diamine monomer selected from C₄ to C₁₀ aliphatic diamines, and a mixture comprising about 0.1 mol % to about 70 mol % of (b2) at least one aliphatic dicarboxylic acid monomer selected from C₄ to C₁₄ aliphatic dicarboxylic acids and the balance of (b1) at least one aromatic dicarboxylic acid monomer selected from aromatic dicarboxylic acids.

14. The method according to claim 13, wherein a ratio of a total mole number of the (a1) aliphatic diamine monomer and the (a2) aliphatic diamine monomer to a total mole number of the (b1) aromatic dicarboxylic acid monomer and the (b2) aliphatic dicarboxylic acid monomer ranges from about 0.9 to about 1.3.

15. An article comprising the polyamide resin according to claim 1.

16. An article comprising a polyamide resin prepared by the method according to claim 13.
